(19) United States
(12) Patent Application Publication
(10) Pub. No.: US 2020/0206758 A1
(43) Pub. Date: Jul. 2, 2020

(54) ASSEMBLY, SYSTEM AND METHOD FOR SUPPLYING LIQUID

(71) Applicant: XIA TAI XIN SEMICONDUCTOR (QING DAO) LTD., Qingdao (CN)

(72) Inventor: YOUNG-SIK PARK, Singapore (SG)

(21) Appl. No.: 16/675,728

(22) Filed: Nov. 6, 2019

Related U.S. Application Data
(60) Provisional application No. 62/779,531, filed on Dec. 14, 2018.

(51) Int. Cl. B05B 1/20; B05B 12/00

(52) U.S. Cl. CPC B05B 1/207; B05B 12/00

(57) ABSTRACT

A liquid supply assembly is provided. The liquid supply assembly includes a receiving portion, a dispersing portion, and two flow controllers. The two flow controllers are connected between the receiving portion and the dispersing portion. A plurality of perforations are formed on the dispersing portion.

### CROSS REFERENCE TO RELATED APPLICATIONS

The present application claims the benefit of and priority to U.S. Provisional Application No. 62/779,531, filed on Dec. 14, 2018, the contents of which are incorporated herein by reference.

### FIELD

The present disclosure relates to semiconductor etching device and more specifically to an apparatus for controlling the dispersion of etchants in an etching bath.

### BACKGROUND

In semiconductor wafer etching, the etching rate is defined as etched depth on a wafer per unit time, and the etching uniformity indicates the variation of etching rates across the wafer. For wet etching, a wafer is soaked in an etching bath filled with an etchant, and the etching uniformity of wet etching may be affected by temperature, concentration, and other factors of the etchant. Poor etching uniformity can negatively affect the quality of the wafer.

### SUMMARY

The following presents a summary of examples of the present disclosure in order to provide a basic understanding of at least some of its examples. This summary is not an extensive overview of the present disclosure. It is not intended to identify key or critical elements of the present disclosure or to delineate the scope of the present disclosure. The following summary merely presents some concepts of the present disclosure in a general form as a prelude to the more detailed description provided below.

In one example, a liquid supply assembly includes a receiving portion, a dispersing portion, and two flow controllers. The two flow controllers are connected between the receiving portion and the dispersing portion. A plurality of perforations are formed on the dispersing portion.

In another example, a wafer processing system includes a wafer processing container and a liquid supply assembly. The liquid supply assembly is configured to disperse liquid in the wafer processing container. The liquid supply assembly includes a receiving portion, a dispersing portion, and two flow controllers. The two flow controllers are connected between the receiving portion and the dispersing portion. A plurality of perforations are formed on the dispersing portion.

In the other example, a method is provided for supplying liquid in a wafer processing container. The method includes: providing a liquid supply assembly comprising a receiving portion, a dispersing portion, and two flow controllers, wherein a plurality of perforations are formed on the dispersing portion; and performing an operation to the two flow controllers.

The details of one or more examples are set forth in the accompanying drawings and description below.

### BRIEF DESCRIPTION OF THE DRAWINGS

The accompanying drawings illustrate one or more implementations of the present disclosure and, together with the written description, explain the principles of the present disclosure. Wherever possible, the same reference numbers are used throughout the drawings referring to the same or like elements of an embodiment.

FIG. 1 is a top view of a liquid supply assembly in accordance with an implementation of the present disclosure.

FIG. 2A is a side view of a wafer processing system having the liquid supply assembly in FIG.1.

FIG. 2B is a top view of the wafer processing system having the liquid supply assembly operating in a first mode in accordance with an implementation of the present disclosure.

FIG. 2C is a top view of the wafer processing system having the liquid supply assembly operating in a second mode in accordance with an implementation of the present disclosure.

FIG. 3A is a top view of a wafer processing system having a pair of the liquid supply apparatuses operating in the first mode in accordance with an implementation of the present disclosure.

FIG. 3B is a top view of a wafer processing system having the pair of the liquid supply apparatuses operating in the second mode in accordance with an implementation of the present disclosure.

### DETAILED DESCRIPTION

To facilitate an understanding of the principles and features of the various implementations of the present disclosure, various illustrative implementations are explained below. Although exemplary implementations of the present disclosure are explained in detail, it is to be understood that other implementations are contemplated. Accordingly, it is not intended that the present disclosure is limited in its scope to the details of construction and arrangement of components set forth in the following description or illustrated in the drawings. The present disclosure is capable of other implementations and of being practiced or carried out in various ways.

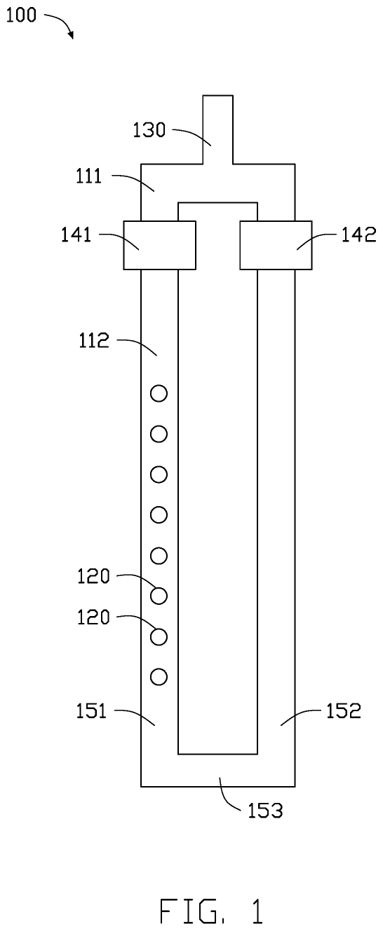

FIG. 1 illustrates a top view of a liquid supply assembly 100 in accordance with an implementation of the present disclosure. The liquid supply assembly 100 includes a receiving portion 111, a dispersing portion 112, a first flow controller 141, a second flow controller 142, and a nozzle 130. The dispersing portion 112 may be a pipe or a tube. Overall shape of the liquid supply assembly 100 may be rectangular, circular, ellipsoidal, or octagonal. Each of the first flow controller 141 and the second flow controller 142 may be a valve. The receiving portion 111 is configured to be connected to ports of the first flow controller 141 and the second flow controller 142. The dispersing portion 112 is configured to be connected to the other ports of the first flow controller 141 and the second flow controller 142. In other words, the receiving portion 111 and the dispersing portion 112 are separated by the first flow controller 141 and the second flow controller 142.

In some embodiments, the dispersing portion 112 includes two long sides 151, 152 and a short side 153. The two long sides 151, 152 and the short side 153 form an U-shaped structure. A plurality of perforations 120 may be formed on the long side 151. Alternatively, the perforations 120 may be formed on the long side 152. In some examples, the perforations 120 may be formed on both of the long sides or the entirety of the dispersing portion 112. In other examples, ejector nozzles (not shown) may be connected to one or more of the perforations 120.

The nozzle 130 is configured to be connected to the receiving portion 111 for receiving liquid sent from a liquid supply source (not shown). The liquid is released from the perforations 120. Preferably, the perforations 120 are formed in alignment with each other; e.g., the perforations 120 are linearly formed along the long side(s). In some examples, the perforations 120 have identical diameters.

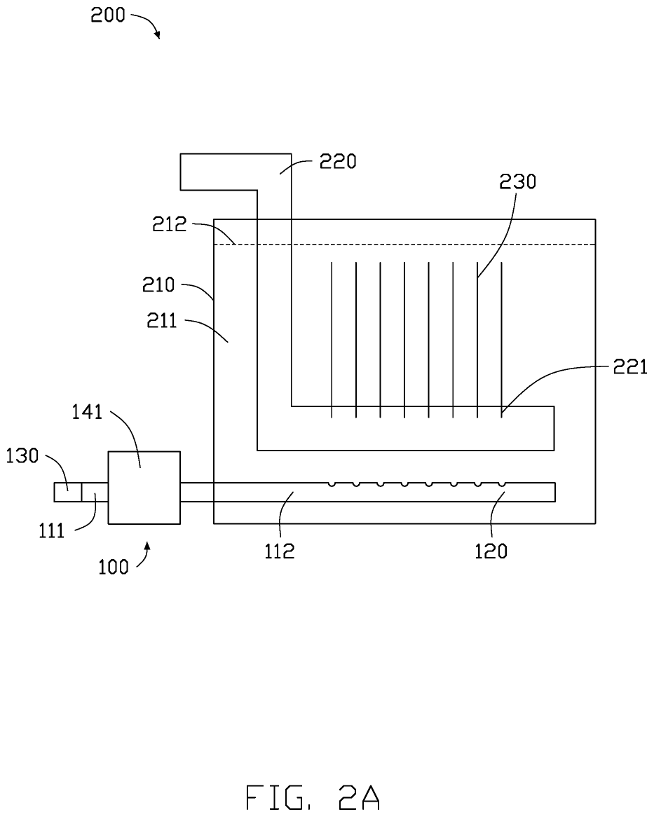

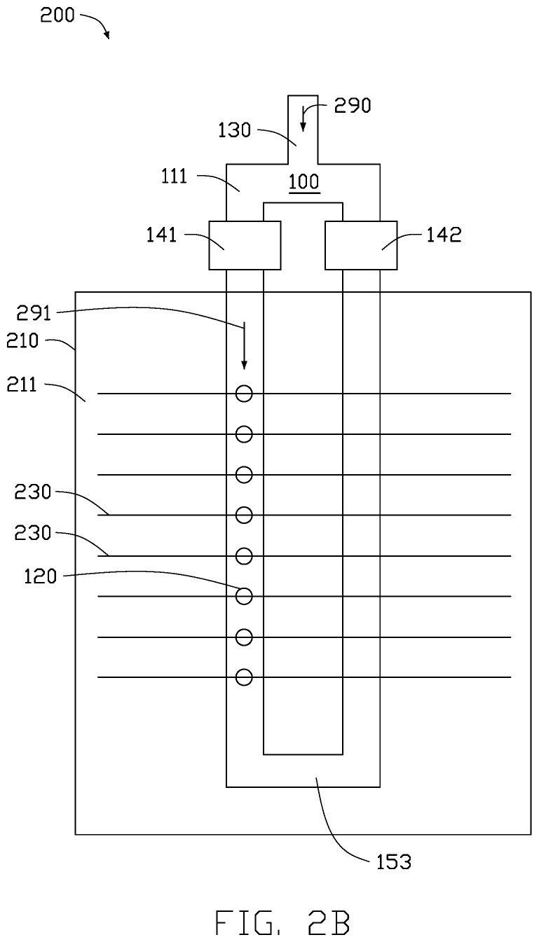

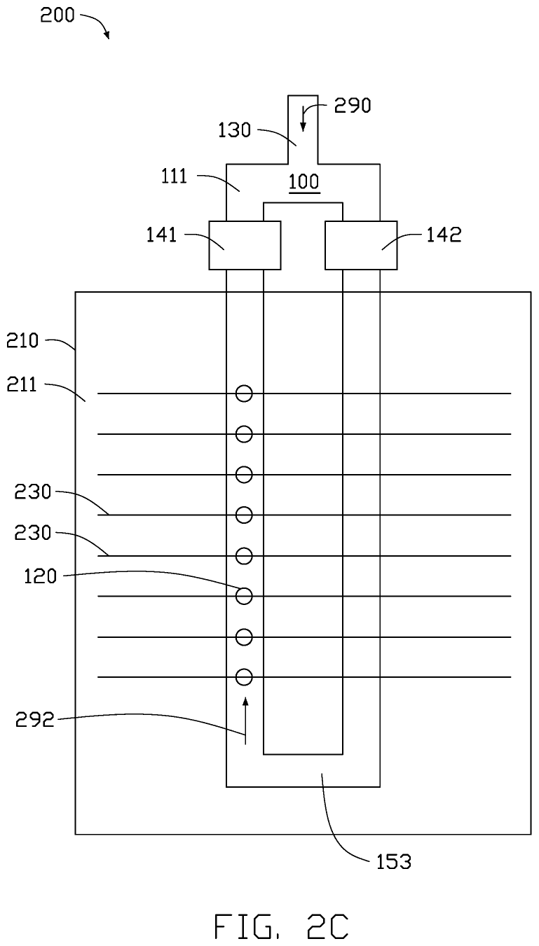

FIG. 2A illustrates a side view of a wafer processing system 200 having the liquid supply assembly 100 in accordance with an implementation of the present disclosure. The wafer processing system 200 includes a wafer processing container 210 (or an etch bath), a wafer boat 220, and the liquid supply assembly 100. The liquid supply assembly 100 is disposed in a predetermined position close to a bottom of the wafer processing container 210. The nozzle 130 is connected to the liquid supply source (not shown). The wafer boat 220 has slots 221 for holding a plurality of wafers 230 in a vertical position. The wafer boat 220 are disposed over the liquid supply assembly 100. For performing a wet etching process, the liquid supply assembly 100 disperses liquid (or etchant) into the wafer processing container 210 through the perforations 120. The liquid may be an etchant such as phosphoric acid. In one implementation, the wafer processing container 210 is filled with the liquid to a level as indicated by a dashed line 212. In some examples, the wafer boat 220 carrying the wafers 230 is descended into the wafer processing container 210 so as to immerse the wafers 230 in the contained liquid 211.

FIG. 2B illustrates a top view of the wafer processing system 200 having the liquid supply assembly 100 operating in a first mode in accordance with an implementation of the present disclosure. The first flow controller 141 and the second flow controller 142 are configured to be coupled to a control module (not shown) for controlling the flow direction of the liquid in the liquid supply assembly 100. As illustrated, the liquid is pumped into liquid supply assembly 100 through the nozzle 130 as indicated by an arrow 290. In the first mode, the first flow controller 141 is opened by the control module, and the second flow controller 142 is closed by the control module. Accordingly, the liquid flows through the first flow controller 141 and toward the perforations 120 in a forward direction as indicated by an arrow 291. Since the second flow controller 142 is shut off, the liquid is released into the wafer processing container 210 sequentially through the perforations 120 in the forward direction, for example, from the perforation 120 closest to the first flow controller 141 to the perforation 120 closest to the short side 153 of the dispersing portion.

FIG. 2C illustrates a top view of the wafer processing system 200 having the liquid supply assembly 100 operating in a second mode in accordance with an implementation of the present disclosure. In the second mode, the first flow controller 141 is closed by the control module, and the second flow controller 142 is opened by the control module. Accordingly, the liquid flows through the second flow controller 142 and toward the perforations 120 as indicated by an arrow 292. Since the first flow controller 141 is shut off, the liquid is released into the wafer processing container 210 sequentially through the perforations 120 in a backward direction, for example, from the perforation 120 closest to short side 153 to the perforation 120 closest to the first flow controller 141.

In some embodiments, the control module is programmed to switch the first flow controller 141 and the second flow controller 142 to a forward mode (first mode) or a backward mode (second mode). In the forward and backward modes, one of the first flow controller and the second flow controller is opened and another of the first flow controller and the second flow controller is closed. Since the liquid are released through the perforations 120 in alternative sequence, the uniformity of the concentration of the contained liquid 211 in the wafer processing container 210 is improved. Correspondingly, the etching uniformity over the wafers in the wafer processing container 210 is improved.

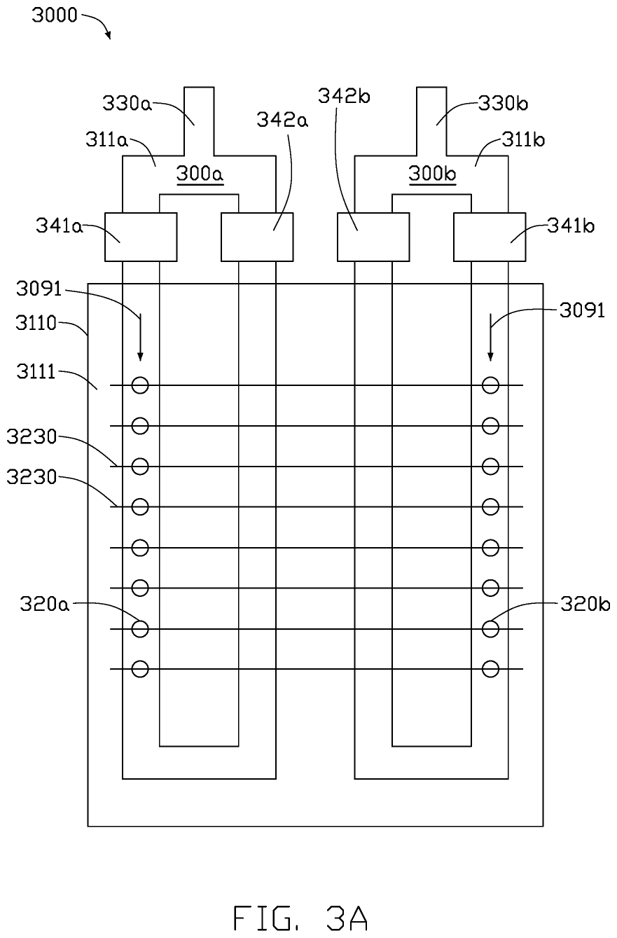

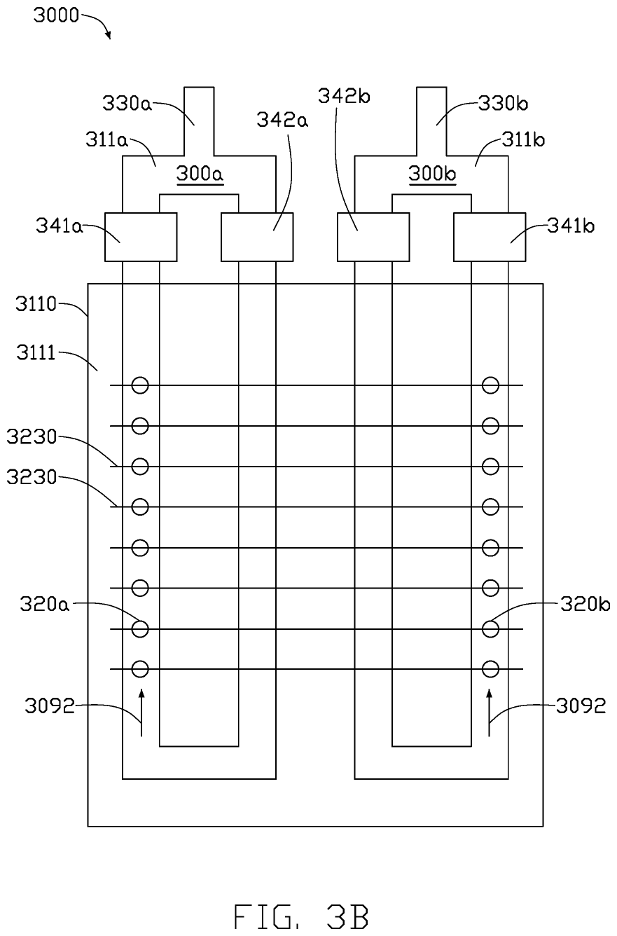

FIG. 3A illustrates a top view of a wafer processing system 3000 having a pair of the liquid supply assemblies 300a and 300b operating in the first mode in accordance with an implementation of the present disclosure. The wafer processing system 3000 includes a wafer processing container 3110 that contains liquid 3111, a wafer boat (not shown) carrying wafers 3230, and the pair of the liquid supply assemblies 300a and 300b for supplying liquid. The liquid supply assembly 300a may be the liquid supply assembly 100 in FIG. 1. The perforations 320b on the liquid supply assembly 300b may be disposed symmetrically to those on the liquid supply assembly 300a, as shown in FIG. 3A.

Flow controllers 341a, 342a, 341b, 342b are configured to be coupled to a control module (not shown) for controlling the flow direction of the liquid in the liquid supply assemblies 300a and 300b. In the first mode, the liquid is pumped into the liquid supply assemblies 300a and 300b through the nozzles 330a and 330b. The flow controllers 341a and 341b are opened by the control module, and the flow controllers 342a and 342b are closed by the control module. Accordingly, the liquid passes through the flow controllers 341a and 341b and flows toward the perforations 320a and 320b in a forward direction as indicated by arrows 3091. Since the flow controllers 342a and 342b are shut off, the liquid is released into the wafer processing container 3110 sequentially through the perforations 320a and 320b in the forward direction.

FIG. 3B illustrates a top view of a wafer processing system 3000 having the pair of the liquid supply assemblies 300a and 300b operating in the second mode in accordance with an implementation of the present disclosure. In the second mode, the flow controllers 342a and 342b are closed by the control module, and the flow controllers 342a and 342b are opened by the control module. Accordingly, the liquid passes through the flow controllers 342a and 342b and flows toward the perforations 320a and 320b in a backward direction as indicated by arrows 3092. Since the flow controllers 342a and 342b are shut off, the liquid is released into the wafer processing container 3110 through the perforations 320a and 320b in the backward direction.

The terminology used herein is for the purpose of describing particular implementations only and is not intended to be limiting of implementations of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to implementations of the present disclosure in the form disclosed. Many modifications and variations will be apparent to those of ordinary skill in the art without departing from the scope and spirit of implementations of the present disclosure. The implementation was chosen and described in order to best explain the principles of implementations of the present disclosure and the practical application, and to enable others of ordinary skill in the art to understand implementations of the present disclosure for various implementations with various modifications as are suited to the particular use contemplated.

Although specific implementations have been illustrated and described herein, those of ordinary skill in the art appreciate that any arrangement which is calculated to achieve the same purpose may be substituted for the specific implementations shown and that implementations of the present disclosure have other applications in other environments. This present disclosure is intended to cover any adaptations or variations of the present disclosure. The following claims are in no way intended to limit the scope of implementations of the present disclosure to the specific implementations described herein.

Various examples have been described. These and other examples are within the scope of the following claims.

What is claimed is:

1. A liquid supply assembly comprising:
a receiving portion;
a dispersing portion; and
two flow controllers connected between the receiving portion and the dispersing portion, wherein a plurality of perforations are formed on the dispersing portion.

2. The liquid supply assembly of claim 1, wherein each of the two flow controllers comprises a valve.

3. The liquid supply assembly of claim 1, wherein the dispersing portion is a pipe or a tube.

4. The liquid supply assembly of claim 1, wherein the dispersing portion is of a U-shaped structure.

5. The liquid supply assembly of claim 1, wherein the dispersing portion comprises two long sides and a short side, and the plurality of perforations are formed on one of the two long sides.

6. The liquid supply assembly of claim 1, further comprising a nozzle configured to be connected to the receiving portion for receiving liquid.

7. The liquid supply assembly of claim 6, wherein the liquid comprises an etchant.

8. The liquid supply assembly of claim 6, wherein the liquid is released from the plurality of perforations.

9. A wafer processing system comprising:
a wafer processing container; and
a liquid supply assembly configured to disperse liquid in the wafer processing container, the liquid supply assembly comprising:
a receiving portion;
a dispersing portion; and
two flow controllers connected between the receiving portion and the dispersing portion, wherein a plurality of perforations are formed on the dispersing portion.

10. The wafer processing system of claim 9, further comprising a control module configured to be coupled to the two flow controllers.

11. The wafer processing system of claim 10, wherein the dispersing portion comprises two long sides and a short side, and the plurality of perforations are formed on one of the two long sides.

12. The wafer processing system of claim 9, wherein the liquid supply assembly further comprises a nozzle configured to be connected to the receiving portion for receiving the chemical liquid.

13. The wafer processing system of claim 9, further comprising a wafer boat disposed over the liquid supply assembly and for holding a plurality of wafers.

14. The wafer processing system of claim 13, wherein the liquid is released from the plurality of perforations and contacts the wafers held by the wafer boat.

15. A method for supplying liquid in a wafer processing container, the method comprising:
providing a liquid supply assembly, wherein the liquid supply assembly comprises a receiving portion, a dispersing portion, and two flow controllers connected between the receiving portion and the dispersing portion and a plurality of perforations are formed on the dispersing portion; and
performing an operation to the two flow controllers.

16. The method of claim 15, wherein the operation comprises switching the two flow controllers to a first mode or a second mode, and in the first and second modes, one of the two flow controllers is open and another of the two flow controllers is closed.
